(19) United States
(12) Patent Application Publication
(10) Pub. No.: US 2022/0365469 A1
(43) Pub. Date: Nov. 17, 2022

(54) SHEET CONVEYANCE APPARATUS AND IMAGE FORMING APPARATUS

(71) Applicant: CANON KABUSHIKI KAISHA, Tokyo (JP)

(72) Inventor: Noriaki Adachi, Chiba (JP)

(21) Appl. No.: 17/737,344

(22) Filed: May 5, 2022

(30) Foreign Application Priority Data
May 13, 2021 (JP) 2021-081415

(51) Int. Cl. G03G 15/23; B65H 5/06; B65H 7/20

(52) U.S. Cl. CPC G03G 15/231; B65H 5/06; B65H 7/20; B65H 2403/72; B65H 2403/40

(57) ABSTRACT

A sheet conveyance apparatus comprises: a first conveyance roller configured to convey a sheet; a second conveyance roller, arranged downstream of the first conveyance roller in the conveyance direction in which the sheet is conveyed, configured to convey the sheet; a first conveyance path configured to guide the sheet from the first conveyance roller to the second conveyance roller; a second conveyance path, which is branched from the first conveyance path between the first conveyance roller and the second conveyance roller to guide the sheet, the second conveyance path having a bent portion; a third conveyance roller configured to convey the sheet guided by the second conveyance path; a first motor configured to drive the third conveyance roller; a second motor; a first transmission mechanism configured to transmit a driving force of the second motor to the second conveyance roller.

### BACKGROUND OF THE INVENTION

### Field of the Invention

The present disclosure relates to a sheet conveyance apparatus which conveys a sheet and an image forming apparatus having the sheet conveyance apparatus.

### Description of the Related Art

An image forming apparatus, such as a printer, a copying machine, a facsimile, and a multifunction apparatus includes a sheet conveyance apparatus to convey a sheet as an original or a recording medium. The image forming apparatus performs printing processing while conveying the sheet by the sheet conveyance apparatus. The sheet conveyance apparatus conveys the sheet by the conveyance roller. The conveyance roller is driven by a stepping motor as a driving source, for example. A stepping motor is generally used as a driving source for a conveyance roller since it can provide an accurate speed control and position control of a sheet with a simple controller configuration.

In recent years, the image forming apparatus is required to form images on a wide variety of types of sheets. Therefore, the sheet conveyance apparatus also needs to stably convey a wide variety of types of sheets. In particular, when conveying a sheet of thick paper, an increased torque (or a higher output) of a conveyance motor is required. Therefore, the output torque may be insufficient in a general-purpose stepping motor used for an image forming apparatus. For example, when a sheet of thick paper is conveyed to a bent portion of a sheet control path, a step-out phenomenon may occur due to an insufficient output torque of the stepping motor. This phenomenon may affect the stable conveyance of the sheet.

When a single high-power motor is used for providing a driving force required for conveying a sheet of thick paper, there are problems such as increased size and cost of the sheet conveyance apparatus and the motor. As a technique for compensating for a lack of driving force, Japanese Patent Application Laid-open No. 2017-184378 provides a technique for connecting a brushless motor and a stepping motor to the same drive shaft to generate a torque in a driving line on a stepping motor side by the brushless motor.

In the image forming apparatus, a position where a high torque is required for conveying a sheet is limited to a position such as a bent portion of a sheet conveyance path. Therefore, a configuration in which a further driving source is added to compensate for the lack of the driving force is not an optimal solution in view of cost. In order to stably convey the sheet, it is sufficient to supply the high torque to a conveyance roller only when a condition in which the high torque is required for conveying the sheet is satisfied.

In view of the above problems, according to the present disclosure, there is provided a sheet conveyance apparatus, as well as an image forming apparatus including the same, in which a sheet is stably conveyed even in a case where high torque is required while suppressing cost.

### SUMMARY OF THE INVENTION

A sheet conveyance apparatus according to one aspect of the present disclosure includes: a first conveyance roller configured to convey a sheet; a second conveyance roller, arranged downstream of the first conveyance roller in a conveyance direction in which the sheet is conveyed, configured to convey the sheet; a first conveyance path configured to guide the sheet from the first conveyance roller to the second conveyance roller; a second conveyance path, which is branched from the first conveyance path between the first conveyance roller and the second conveyance roller to guide the sheet, the second conveyance path having a bent portion; a third conveyance roller configured to convey the sheet guided by the second conveyance path; a first motor configured to drive the third conveyance roller; a second motor; a first transmission mechanism configured to transmit driving force of the second motor to the second conveyance roller; and a second transmission mechanism configured to transmit the driving force of the second motor to the third conveyance roller, wherein, in a case where the sheet is conveyed by the second conveyance roller, the driving force of the second motor is transmitted to the second conveyance roller by the first transmission mechanism and the driving force of the second motor is not transmitted to the third conveyance roller, wherein, in a case where the sheet is conveyed by the third conveyance roller, the driving force of the second motor is transmitted to the third conveyance roller by the second transmission mechanism and the driving force of the second motor is not transmitted to the second conveyance roller, and wherein, in a case where the sheet is conveyed by the third conveyance roller, the third conveyance roller is driven by both the first motor and the second motor.

An image formation apparatus according to one aspect of the present disclosure includes: a transfer unit configured to transfer an image on a recording medium; a fixing unit configured to fix the image transferred on the recording medium by the transfer unit on the recording medium with heat; a discharge roller configured to discharge the recording medium on which a first image as the image is fixed by the fixing unit to an outside of the image forming apparatus; a first conveyance path configured to guide the recording medium to the discharge roller from the fixing unit; a second conveyance path configured to guide the recording medium having a first surface on which the first image is fixed by the fixing unit and a second surface, which is an opposite side of the first surface, on which a second image as the image is to be formed, wherein the second conveyance path is branched from the first conveyance path between the fixing unit and the discharge roller, and the second conveyance path has a bent portion; a conveyance roller configured to convey the recording medium guided by the second conveyance path; a first motor configured to drive the conveyance roller; a second motor; a first transmission mechanism configured to transmit driving force of the second motor to the discharge roller; and a second transmission mechanism configured to transmit the driving force of the second motor to the conveyance roller, wherein, in a case where the recording medium is conveyed by the discharge roller, the driving force of the second motor is transmitted to the discharge roller by the first transmission mechanism and the driving force of the second motor is not transmitted to the conveyance roller, wherein, in a case where the recording medium is conveyed by the conveyance roller, the driving force of the second motor is transmitted to the conveyance roller by the second transmission mechanism and the driving force of the second motor is not transmitted to the discharge roller, wherein, in a case where the recording medium is conveyed by the conveyance roller, the conveyance roller is driven by both the first motor and the second motor.

Further features of the present invention will become apparent from the following description of exemplary embodiments (with reference to the attached drawings).

### BRIEF DESCRIPTION OF THE DRAWINGS

FIG. 1 is an explanatory configuration diagram of an image forming apparatus.

FIG. 2 is an explanatory configuration diagram of a control system.

FIG. 3 is a detailed explanatory configuration diagram of a discharge unit and a reversal double-sided unit of a comparison example.

FIG. 4 is a detailed configuration diagram of the discharge unit and the reversal double-sided unit of the present disclosure.

FIG. 5 is a flow chart representing a conveyance control process of the sheet.

FIG. 6 is a flow chart representing the conveyance control process of the sheet.

FIG. 7 is a flow chart representing the conveyance control process of the sheet.

FIG. 8A and FIG. 8B are timing charts representing conveyance timings of a sheet.

FIG. 9A and FIG. 9B are timing charts representing the conveyance timing of a sheet.

FIG. 10A and FIG. 10B are timing charts representing the conveyance timing of a sheet.

### DESCRIPTION OF THE EMBODIMENTS

Hereinafter, embodiments for carrying out the present disclosure will be described with reference to the drawings.

### <The Image Forming Apparatus>

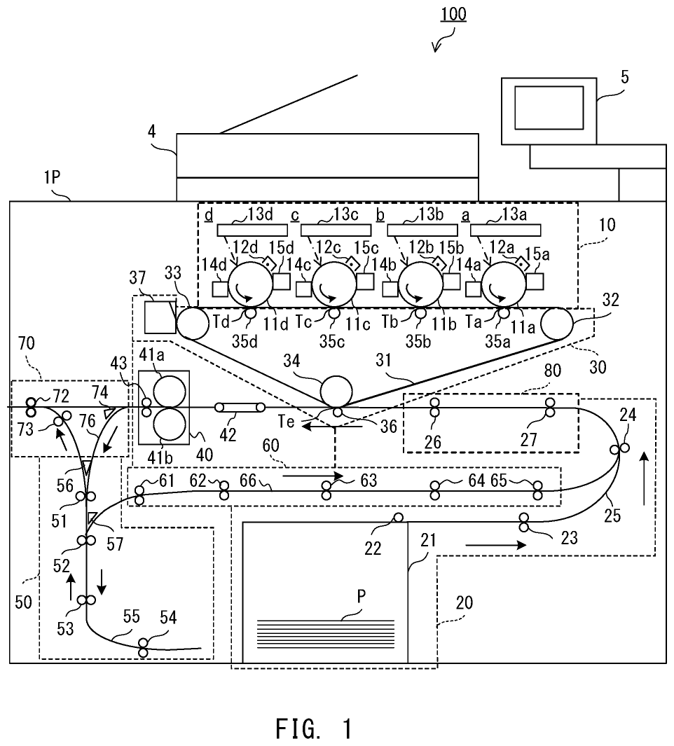

FIG. 1 is an explanatory configuration diagram of an image forming apparatus having a sheet conveyance apparatus of the present disclosure. An image forming apparatus 100 is a color image forming apparatus having an image output unit 1P, a reader unit 4 arranged above the image output unit 1P, and an operation unit 5. The reader unit 4 serves as an image reading apparatus which reads an original image from an original. The operation unit 5 is a user interface including an input interface and an output interface. The input interface is, for example, a touch panel or various key buttons. The output interface is a display or a speaker which displays information. The image forming apparatus 100 includes, for example, a copier, a multifunction apparatus, an MFP (Multi-Function Peripheral), and the like.

The image output unit 1P operates in response to an instruction obtained via the operation unit 5. For example, the image output unit 1P prints the original image read by the reader unit 4 on a sheet P to perform a copying operation of the original image. Further, the image output unit 1P performs a printing operation by printing an image on the sheet P based on image data stored in a storage (not shown). The image output unit 1P includes an image forming unit 10, a feeding unit 20, an intermediate transfer unit 30, a pre-fixing conveyance unit 42, a fixing device 40, a reversal double-sided unit 50, a double-sided conveyance unit 60, a discharge unit 70, and a registration unit 80. The fixing device 40, the pre-fixing conveyance unit 42, the double-sided conveyance unit 60, and the registration unit 80 are integrally configured as a fixing and conveyance unit, and it is easily withdrawn from the image forming apparatus 100.

The image forming unit 10 includes four image forming stations a, b, c, and d arranged side by side in a horizontal direction. The four image forming stations a, b, c, and d have the same configuration. The image forming stations a, b, c, and d includes respective photosensitive drums 11a, 11b, 11c, and 11d as a photosensitive member. The photosensitive drums 11a, 11b, 11c, and 11d are supported by a drum axis, and are rotated in a direction of an arrow. Chargers 12a, 12b, 12c, and 12d, optical systems 13a, 13b, 13c, and 13d, developing unit 14a, 14b, 14c, and 14d, and cleaners 15a, 15b, 15c, and 15d are provided, facing an outer peripheral surface of respective photosensitive drums 11a, 11b, 11c, and 11d, along the rotation direction of the respective photosensitive drums.

The chargers 12a, 12b, 12c, and 12d give a uniform amount of charge to surfaces of the corresponding photosensitive drums 11a, 11b, 11c, and 11d. As a result, the surfaces of the photosensitive drums 11a, 11b, 11c, and 11d are uniformly charged. The optical systems 13a, 13b, 13c, and 13d irradiate the uniformly charged surfaces of the corresponding photosensitive drums 11a, 11b, 11c, and 11d with light beams such as laser beams which are modulated according to the image data. As a result, an electrostatic latent image is formed on the surface of each of the photosensitive drums 11a, 11b, 11c, and 11d. The developing units 14a, 14b, 14c, and 14d store black (k), cyan (c), magenta (m), and yellow (y) toners, respectively. The developing units 14a, 14b, 14c, and 14d supply toner to the electrostatic latent images formed on the corresponding photosensitive drums 11a, 11b, 11c, and 11d, and visualize it to form a toner image. Each of the toner images of each color formed on the photosensitive drums 11a, 11b, 11c, and 11d is transferred by superimposing it on an intermediate transfer belt 31 described later, by applying a predetermined transfer voltage to primary transfer rollers 35a, 35b, 35c, and 35d, which serve as the primary transfer portions of an intermediate transfer unit 30 described later. The cleaners 15a, 15b, 15c, and 15d scrape off residual toner, which is not transferred to the intermediate transfer belt 31 and remains on the photosensitive drums 11a, 11b, 11c, and 11d, to clean the surfaces of the photosensitive drums 11a, 11b, 11c, and 11d.

A feeding unit 20 includes a cassette 21 to store a sheet P. The feeding unit 20 includes a pickup roller 22, a plurality of conveyance rollers 23 and 24 for conveying the sheet P fed from the cassette 21 to the registration unit 80, and a conveyance guide 25. The registration unit 80 includes a pre-registration roller 27 and a registration roller 26. The pickup roller 22 feeds the sheet P one by one from the cassette 21. The fed sheet P is conveyed by the conveyance rollers 23 and 24 to the pre-registration roller 27 through the conveyance guide. The pre-registration roller 27 conveys the sheet P to the registration roller 26. The registration roller 26 corrects a skew of the sheet P and conveys the sheet P toward a secondary transfer region Te of the intermediate transfer unit 30, which will be described later, in accordance with a timing of image forming.

The intermediate transfer unit 30 has an intermediate transfer belt 31 as an intermediate transfer member. The intermediate transfer belt 31 is rotatably stretched by a driving roller 32, a tension roller 33, and a secondary transfer inner roller 34. The driving roller 32 transmits driving force to the intermediate transfer belt 31. The tension roller 33 applies an appropriate tension to the intermediate transfer belt 31 by an urging force of an elastic member such as a spring (not shown). A secondary transfer outer roller 36 is arranged at a position facing the secondary transfer inner roller 34 with the intermediate transfer belt 31 interposed therebetween.

The primary transfer rollers 35a, 35b, 35c, and 35d are arranged so as to face respective photosensitive drums 11a, 11b, 11c, and 11d via the intermediate transfer belt 31. Contact portions between the photosensitive drums 11a, 11b, 11c, and 11d and the primary transfer rollers 35a, 35b, 35c, and 35d are primary transfer regions Ta, Tb, Tc, and Td. Each of the toner images formed on each of the photosensitive drums 11a, 11b, 11c, and 11d is transferred by superimposing it on the image forming surface of the intermediate transfer belt 31 in the primary transfer regions Ta, Tb, Tc, and Td.

A contact portion between the secondary transfer inner roller 34 and the secondary transfer outer roller 36 is a secondary transfer region Te which is a secondary transfer portion. Each toner image of each color transferred on the intermediate transfer belt 31 is transferred on the sheet P conveyed by the registration roller 26 at the secondary transfer region Te. A cleaner 37 is arranged at a position facing the tension roller 33 via the intermediate transfer belt 31. The cleaner 37 cleans, after the toner image has been transferred to the sheet P, an image forming surface of the intermediate transfer belt 31.

The pre-fixing conveyance unit 42 is arranged between the secondary transfer region Te and the fixing device 40. The pre-fixing conveyance unit 42 conveys the sheet P from the secondary transfer region Te to the fixing device 40 by absorbing the sheet P by the conveyance belt to rotate.

Into the fixing device 40, the sheet P is conveyed from the secondary transfer region Te via the pre-fixing conveyance unit 42. The fixing device 40 includes a fixing roller 41a, a pressing roller 41b, a pre-fixing guide (not shown) which guides the sheet P to a nip portion of the fixing roller 41a and a pressing roller 41b, and an inner discharge roller 43 which discharges the sheet P from the fixing device 40. The fixing roller 41a has a heat source such as a halogen heater inside. The pressing roller 41b is pressurized by the fixing roller 41a. The pressing roller 41b may also have a heat source. The fixing device 40 fixes an image on the sheet P by heating and pressurizing the toner image transferred on the sheet P in the secondary transfer region Te at the nip portion. The inner discharge roller 43 conveys the sheet P, after the image is fixed, to the discharge unit 70.

A discharge unit 70 has an outer discharge roller 72, a pre-discharge roller 73, a flapper 74, and a conveyance guide 76. The outer discharge roller 72 discharges the sheet P to an outside of the image forming apparatus 100. The pre-discharge roller 73 draws the sheet P from the reversal double-sided unit 50 to convey it to the outer discharge roller 72. The flapper 74 distributes a conveyance destination of the sheet P to either a direction toward the reversal double-sided unit 50 as a reversal portion and a direction toward the outer discharge roller 72. As to the sheet P that is distributed by the flapper 74 to the direction toward the reversal double-sided unit 50, the conveyance guide 76 guides it to the reversal double-sided unit 50.

The reversal double-sided unit 50 has a plurality of reversal rollers 51 and 52, reversal double-sided rollers 53 and 54, a reversal double-sided guide 55, a reversal flapper 56, and a double-sided flapper 57. The reversal rollers 51 and 52 are configured such that they can rotate in a normal direction and a reverse direction. The reversal flapper 56 guides the sheet P reversed by the reversal double-sided guide 55 toward the pre-discharge roller 73 and the outer discharge roller 72 of the discharge unit 70 at the time of reversal discharge. The double-sided flapper 57 guides the sheet P in a direction toward the double-sided conveyance unit 60 during double-sided printing. Details of an arrangement of the sensors of a drive configuration of the discharge unit 70 and the reversal double-sided unit 50 will be described later.

The double-sided conveyance unit 60 has a plurality of double-sided conveyance rollers 61, 62, 63, 64, and 65, and a double-sided conveyance guide 66 which guides the sheet P in order to convey the sheet P to the conveyance guide 25 of the feeding unit 20. At the time of double-sided printing, the sheet P on which an image has been formed on one side (first side) is conveyed to the conveyance guide 25 with a surface on which the image is to be formed is reversed by the reversal double-sided unit 50 and the double-sided conveyance unit 60. Then, an image is formed on the reversed surface (second surface).

The image forming apparatus 100 having the above configuration starts image formation on the sheet P by obtaining an image forming operation start signal from the operation unit 5 or an external device (not shown). The external device is a personal computer or a server connected via a network such as a LAN (Local Area Network).

The feeding unit 20 feeds the sheet P from the cassette 21 one by one by the pickup roller 22 in response to the image forming operation start signal. The fed sheet P is conveyed to the pre-registration roller 27 by the conveyance rollers 23 and 24 to convey the conveyance guide 25 to the pre-registration roller 27. The pre-registration roller 27 conveys the sheet P to the registration roller 26 which is in a stopped state.

Therefore, the sheet P collides with a nip portion of the registration roller which is in the stopped state to form a loop on a leading edge side of the sheet P. By forming the loop, a skew of the sheet P is corrected. After the skew correction, the registration roller 26 starts rotation according to the timing at which the image forming unit 10 starts image forming, and conveys the sheet P to the secondary transfer region Te. A rotation start time of the registration roller 26 is set at a timing at which the leading edge of the sheet P and a leading edge of the toner image conveyed by the intermediate transfer belt 31 coincide with each other in the secondary transfer region Te.

The image forming unit 10 forms toner images of the corresponding color on each of the photosensitive drums 11a, 11b, 11c, and 11d by the above process according to the image forming operation start signal. The toner image is superimposed and transferred on the intermediate transfer belt 31 in order from the photosensitive drum 11d, which is located at the most upstream in a rotation direction of the intermediate transfer belt 31. As a result, a full-color toner image is formed on the intermediate transfer belt 31. The full-color toner image supported on the intermediate transfer belt 31 is conveyed to the secondary transfer region Te by rotation of the intermediate transfer belt 31.

For example, the toner image formed on the photosensitive drum 11d is transferred (primary transfer), by applying a high voltage on the primary transfer roller 35d, on the intermediate transfer belt 31 in the primary transfer region Td. The toner image transferred from the photosensitive drum 11d is conveyed to the primary transfer region Tc by rotation of the intermediate transfer belt 31. On the photosensitive drum 11c, the toner image is formed with a delay of time to convey the toner image from the primary transfer region Td to the primary transfer region Tc. Therefore, the toner image formed on the photosensitive drum 11c is superimposed and transferred on the toner image on the intermediate transfer belt 31 which has been conveyed. Hereinafter, in the same process, the toner image is sequentially transferred from the photosensitive drums 11a and 11b to the intermediate transfer belt 31.

In the secondary transfer region Te, a high voltage is applied to the secondary transfer outer roller 36 at a timing when the sheet P contacts with the intermediate transfer belt 31. As a result, the full-color toner image supported on the intermediate transfer belt 31 is transferred (secondary transfer) to the sheet P. The sheet P to which the toner image has been transferred is conveyed to the pre-fixing conveyance unit 42 by a secondary transfer outer roller 36. The pre-fixing conveyance unit 42 accurately conveys the sheet P to which the toner image has been transferred to a nip portion of the fixing roller 41a and the pressing roller 41b of the fixing device 40.

The fixing device 40 fixes the toner image on the surface of the sheet P by heating and pressurizing the toner image with the fixing roller 41a and the pressing roller 41b. From a viewpoint of fixability, the fixing device 40 conveys thick paper having a basis weight of 350 g/m² or the like at a conveyance speed which is about half the conveyance speed of plain paper. The sheet on which the toner image has been fixed is conveyed from the fixing device 40 to the discharge unit 70 by the inner discharge roller 43.

When performing a reversal discharge or forming an image during double-sided printing, after printing an image on a front surface, on a back surface of the sheet P, the sheet P is conveyed to the reversal double-sided unit 50 by a flapper 74 via the conveyance guide 76. When performing a straight discharge or after printing an image on the back surface during double-sided printing, the sheet P is conveyed to the outer discharge roller 72 by the flapper 74, and is discharged to the outside of the image forming apparatus 100 from the image output unit 1P by the outer discharge roller 72. The term “reversal discharge” is a process of discharging the sheet to the outside of the image forming apparatus 100 with the side on which the image has been formed facing down during single-sided printing. The term “straight discharge” is a process of discharging the image to the outside of the image forming apparatus 100 with the side on which the image has been formed facing up during single-sided printing.

The sheet P guided to the reversal double-sided unit 50 is conveyed to the reversal double-sided guide 55 by the reversal rollers 51 and 52 and the reversal double-sided rollers 53 and 54. The sheet P stops at a position where its trailing edge passes through the reversal roller 51 during reversal discharge, and stops at a position where its trailing edge passes through the reversal roller 52 during double-sided printing. After the sheet P has stopped, the reversal rollers 51 and 52 and the reversal double-sided rollers 53 and 54 rotate in a reverse direction.

In the case of the reversal discharge, the sheet P is conveyed by the reversal flapper 56 in a direction toward the pre-discharge roller 73 and the outer discharge roller 72 of the discharge unit 70. The sheet P guided by the reversal flapper 56 is drawn into the pre-discharge roller 73, and is discharged to the outside of the image forming apparatus from the image output unit 1P by the outer discharge roller 72. In the case of double-sided printing, the sheet P is conveyed in a direction toward the double-sided conveyance unit 60 by the double-sided flapper 57. The sheet P guided to the double-sided conveyance unit 60 by the double-sided flapper 57 is conveyed by the double-sided conveyance rollers 61, 62, 63, 64, and 65 through the double-sided conveyance guide 66 and joins the conveyance guide 25 of the feeding unit 20. After that, on the sheet P, an image is formed on its back surface (second surface) by the same processing as the processing performed when printing on its front surface (first surface). The sheet P, having images formed on both sides, is discharged to the outside of the image forming apparatus 100 from the image output unit 1P by the outer discharge roller 72 via the straight discharge.

The sheet P needs to pass through the bent conveyance guide 76 (bent portion) when conveyed from the fixing device 40 in the direction toward the reversal double-sided unit 50. When the sheet P is thick paper, high torque driving force is required to convey the sheet P through the bent portion. The image forming apparatus 100 (the sheet conveyance apparatus) of the present embodiment is advantageously applied to conveyance of the sheet P that requires the high torque for conveying the same such as thick paper.

### <Control System>

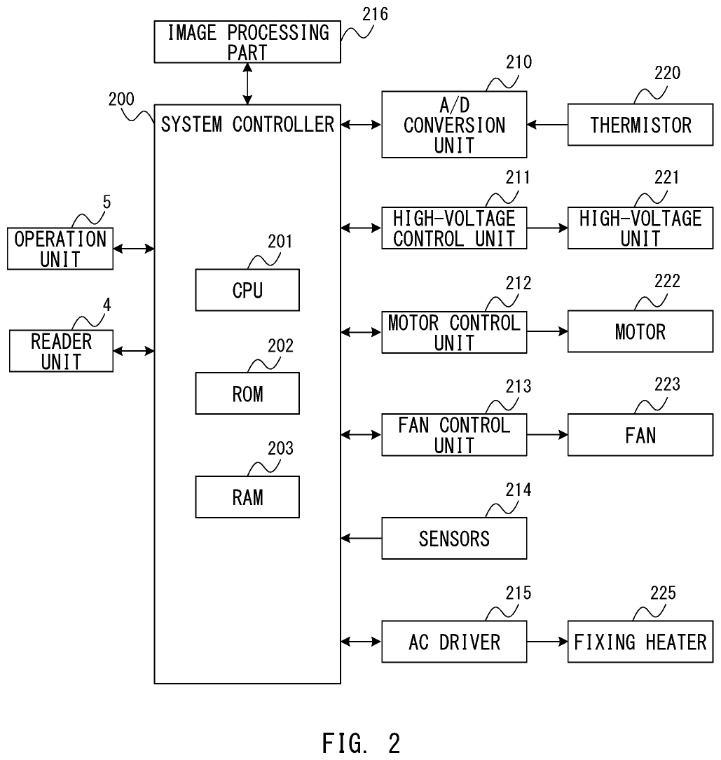

FIG. 2 is an explanatory configuration diagram of a control system of the image forming apparatus 100. A system controller 200 comprehensively controls the operation of the image forming apparatus 100 as a whole. The system controller 200 serves to control the drive of each load in the image forming apparatus 100, information collection analysis using sensors, an operation control of the image output unit 1P by an image processing part 216, and data exchange with the operation unit 5 and the like. Although it is omitted in FIG. 2, the system controller 200 may be configured to communicate with an external device via a communication interface.

The system controller 200 includes a CPU (Central Processing Unit) 201, an ROM (Read Only Memory) 202, and an RAM (Random Access Memory) 203. The image processing part 216, the operation unit 5, an analog-to-digital (A/D) conversion unit 210, a high-voltage control unit 211, a motor control unit 212, a fan control unit 213, sensors 214, an AC driver 215, and the reader unit 4 are connected to the system controller. The system controller 200 can send/receive data to/from each of the connected units which are related to image forming.

The CPU 202 executes various computer programs stored in the ROM 202 to perform various control sequences related to the image forming process. The RAM 203 is a volatile memory device and provides a work area for the CPU 201 to execute various programs. Further, the RAM 203 provides a temporary storage area for temporarily storing various data. The RAM 203 stores, for example, a set value for the high-voltage control unit 211, a command value for the motor control unit 212, a detection result obtained from the sensors 214, information obtained from the operation unit 5, and the like.

The system controller 200 transmits to the image processing part 216 a setting value of each device in the image forming apparatus 100 necessary for the image forming process. The image processing part 216 controls the operation of each device in the image forming apparatus 100 according to the setting value. Further, the system controller 200 obtains, from the reader unit 4, image data representing the original image read by the reader unit 4. The system controller 200 transmits the obtained image data to the image processing part 216. The image processing part 216 performs predetermined processing on the image data to use the same for the image forming by the image output unit 1P.

The system controller 200 displays an operation screen for the user to set various settings on the display section of the operation unit 5. The system controller 200 receives an instruction from the user according to the operation screen via the input interface of the operation unit 5. For example, the system controller 200 receives instructions, via the operation unit 5, for the printing condition such as the size of the sheet P used for image forming, basis weight, the number of prints, setting values for a copy magnification and print density, and single-sided printing/double-sided printing. Further, the system controller 200 transmits data for notifying the user of the status of the image forming apparatus 100 to the operation unit 5. Based on the data received from the system controller 200, the operation unit 5 displays information indicating the state of the image forming apparatus 100 (for example, the number of images formed, information indicating whether or not an image is being formed, and the occurrence and location of jam) on the display screen section.

The system controller 200 receives signals from each device (signals from a thermistor 220, detection results of sensors 214, etc.,) and controls each device based on the received signals. For example, the system controller 200 inputs a predetermined setting value to the high-voltage control unit 211. The high-voltage control unit 211 supplies a required voltage to the high-voltage unit 221 based on the set value set by the system controller 200. The high-voltage unit 221 is a component which uses a high-voltage for the operations of the chargers 12a, 12b, 12c, and 12d, the developing units 14a, 14b, 14c, and 14d, and the primary transfer rollers 35a, 35b, 35c, and 35d, etc. The setting values set by the system controller 200 are generated based on the signal from each device.

The A/D conversion unit 210 receives a detection signal from the thermistor 220 for detecting a temperature of a fixing heater 225, converts the detection signal into a digital signal to transmit the same to the system controller 200. The fixing heater 225 is provided in the fixing device 40 (the fixing roller 41a), and is a heat source for heating the sheet P during a fixing process. The system controller 200 detects the temperature of the fixing heater 225 based on the digital signal received from the A/D conversion unit 210. The system controller 200 controls the AC driver 215 based on the detected temperature of the fixing heater 225 to provide feedback control of the temperature of the fixing heater 225 for a predetermined temperature for the fixing process.

The system controller 200 controls the drive of a motor 222 via the motor control unit 212. The motor control unit 212 controls the drive of the motor 222 based on a command value obtained from the system controller 200. Although only one motor is shown in FIG. 2, a plurality of motors are actually driven and controlled by the motor control unit 212. The reversal motor and the discharge motor described later are also installed in the motor 222.

The system controller 200 controls the drive of the fan 223 via the fan control unit 213. The fan control unit 213 controls the drive of a plurality of fan 223 based on the command values obtained from the system controller 200. By controlling the drive of the fan, an airflow control of image forming apparatus 100 is performed.

### <Configuration of Discharge Unit 70 and Reversal Double-Sided Unit 50>

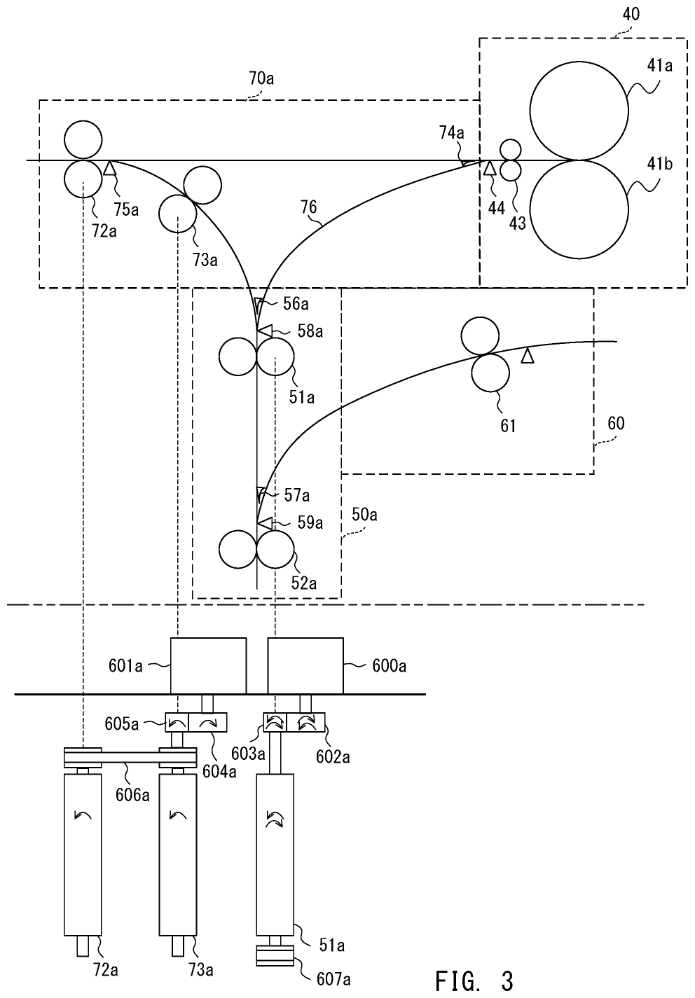

FIG. 3 is a detailed explanatory configuration diagram of the discharge unit and the reversal double-sided unit of a comparison example. FIG. 3 represents a sensor arrangement and a drive configuration of the discharge unit 70a and a reversal double-sided unit 50a. The fixing device 40 is provided with an inner discharge sensor 44 for detecting the sheet P on the downstream of the inner discharge roller 43 in the conveyance direction of the sheet P.

A reversal sensor 58a is arranged on the discharge unit 70a side of a reversal roller 51a. A reversal double-sided sensor 59a is arranged on the reversal roller 51a side of a reversal roller 52a. The system controller 200 controls the conveyance of the sheet P in the reversal double-sided unit 50a and confirms a stop position based on each detection result of the sheet P of the reversal sensor 58a and the reversal double-sided sensor 59a. A discharge sensor 75a is arranged on the upstream side of an outer discharge roller 72a in the conveyance direction of the sheet P. The system controller 200 detects the discharge state of the sheet P based on the detection result of the sheet P by the discharge sensor 75a.

The reversal rollers 51a and 52a of the reversal double-sided unit 50a are rotationally driven by using a reversal motor 600a as a drive source. The driving force of the reversal motor 600a is transmitted to the reversal roller 51a via gears 602a and 603 a. The reversal roller 51a and the reversal roller 52a are driven and connected by a belt 607a. The driving force of the reversal motor 600a is transmitted to the reversal roller 52a via the gears 602a, 603a, and the belt 607a.

The reversal motor 600a can rotate in two directions. When the reversal motor 600a rotates in a CW (Clockwise) direction, the reversal rollers 51a and 52a operate in a direction of drawing the sheet P conveyed from the fixing device 40 into the reversal double-sided unit 50a. When the reversal motor 600a rotates in a CCW (Counterclockwise) direction, the reversal rollers 51a and 52a rotate in a reverse direction and operate to convey the sheet P in a direction toward the discharge unit 70a or a direction toward the double-sided conveyance unit 60 direction.

The outer discharge roller 72a and a pre-discharge roller 73a of the discharge unit 70a are rotationally driven by using a discharge motor 601a as a drive source. The driving force of the discharge motor 601a is transmitted to the pre-discharge roller 73a via gears 604a and 605a. The pre-discharge roller 73a and the outer discharge roller 72a are driven and connected by a belt 606a. The driving force of the discharge motor 601a is transmitted to the outer discharge roller 72a via the gears 604a, 605a, and the belt 606a. The discharge motor 601a rotates in only one direction, i.e., in the CW direction. Due to the rotation of the discharge motor 601a, the outer discharge roller 72a and the pre-discharge roller 73a operate in a direction of discharging the sheet P to the outside of the image forming apparatus 100.

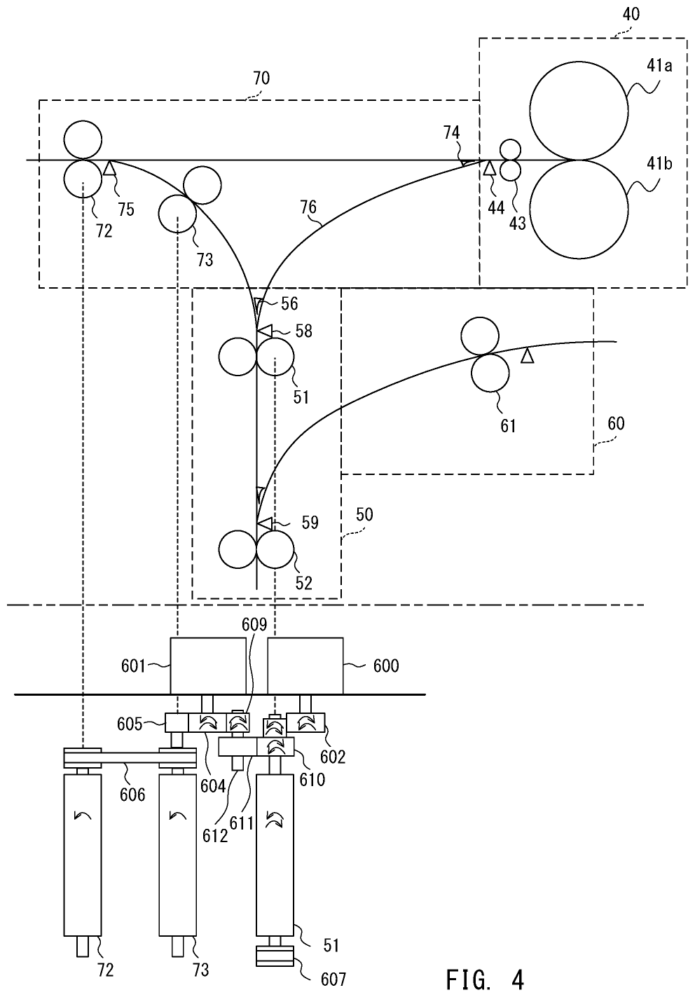

FIG. 4 is a detailed explanatory configuration diagram of the discharge unit 70 and the reversal double-sided unit 50 of the present embodiment. FIG. 4 represents a sensor arrangement and a drive configuration of the discharge unit 70 and the reversal double-sided unit 50. The fixing device 40 has the inner discharge sensor 44 for detecting the sheet P on the downstream of the inner discharge roller 43 in the conveyance direction of the sheet P. In the present embodiment, the configuration and the operation of the sheet conveying apparatus will be described with the discharge unit 70 and the reversal double-sided unit 50 and a configuration of the system controller 200, the motor control unit 212, a reversal motor 600, and a discharge motor 601. The reversal motor 600 and the discharge motor 601 are, for example, stepping motors. By using a stepping motor for the reversal motor 600 and the discharge motor 601, it is possible to accurately control the conveyance speed and a position of the sheet P in the discharge unit 70 and the reversal double-sided unit 50.

A reversal sensor 58 is arranged on the discharge unit 70 side of the reversal roller 51. A reversal double-sided sensor 59 is arranged on the reversal roller 51 side of the reversal roller 52. The system controller 200 controls the conveyance of the sheet P in the reversal double-sided unit 50 and confirms a stop position based on each detection result of the sheet P of the reversal sensor 58 and the reversal double-sided sensor 59. A discharge sensor 75 is arranged on the upstream side of the outer discharge roller 72 in the conveyance direction of the sheet P. The system controller 200 detects the discharge state of the sheet P based on the detection result of the sheet P by the discharge sensor 75.

The reversal rollers 51 and 52 of the reversal double-sided unit 50 are rotationally driven by using the reversal motor 600 as a drive source. The driving force of the reversal motor 600 is transmitted to the reversal roller 51 via a gear 602 and a two-stage gear 610, which serve as a driving force transmission mechanism. The gear 602 is connected to the reversal motor 600, and the two-stage gear 610 is connected to the reversal roller 51. The reversal roller 51 and the reversal roller 52 are driven and connected by a belt 607. The driving force of the reversal motor 600 is transmitted to the reversal roller 52 via the gear 602, the two-stage gear 610, and the belt 607.

The reversal motor 600 is rotatable in two directions. When the reversal motor 600 rotates in a CW direction, the reversal rollers 51 and 52 operate in a direction of drawing the sheet P conveyed from the fixing device 40 into the reversal double-sided unit 50. When the reversal motor 600 rotates in a CCW direction, the reversal rollers 51 and 52 rotate in a reverse direction and operate to convey the sheet P in a direction toward the discharge unit 70 or the direction toward the double-sided conveyance unit 60.

The outer discharge roller 72 and the pre-discharge roller 73 of the discharge unit 70 are rotationally driven by using the discharge motor 601 as a drive source. The driving force of the discharge motor 601 is transmitted to the pre-discharge roller 73 via gears 604 and 605, which serve as the driving force transmission mechanism. The gear 604 is connected to the discharge motor 601, and the gear 605 is connected to the pre-discharge roller 73. The pre-discharge roller 73 and the outer discharge roller 72 are driven and connected by belt 606. The driving force of the discharge motor 601 is transmitted to the outer discharge roller 72 via the gears 604, 605, and the belt 606. The discharge motor 601 is rotatable in two directions. The gear 605 is a one-way clutch gear. Therefore, the outer discharge roller 72 and the pre-discharge roller 73 rotate in a direction to discharge the sheet P to the outside of the image forming apparatus 100 in a case where the discharge motor 601 rotates in the CW direction. On the other hand, the outer discharge roller 72 and the pre-discharge roller 73 do not rotate in a case where the discharge motor 601 rotates in the CCW direction since the driving force is not transmitted.

The gear 604 is connected to an idler gear 609. The idler gear 609 is integrally connected to an idler gear shaft 612. The idler gear shaft 612 pivotally supports a one-way clutch gear 611. The one-way clutch gear 611 is connected to the two-stage gear 610. The idler gear 609, the idler gear shaft 612, and the one-way clutch gear 611 constitute a mechanism for transmitting the driving force from the discharge motor 601 to the reversal roller 51. When the discharge motor 601 rotates in the CCW direction, the one-way clutch gear 611 engages with the two-stage gear 610 to thereby transmit the driving force of the discharge motor 601 to the reversal rollers 51 and 52. The driving force transmitted at this time acts in a direction in which the reversal rollers 51 and 52 draws the sheet P. Therefore, the driving force transmitted in this way can assist the driving force of the reversal rollers 51 and 52 when the sheet P passes through the conveyance guide 76, which is a bent portion. In this configuration, since the one-way clutch gear 611 is provided, the driving force of the reversal motor 600 and the driving force of the discharge motor 601 do not interfere with each other. Further, the driving force of the discharge motor 601 assists the driving force of the reversal rollers 51 and 52 only at the timing when the pre-discharge roller 73 and the outer discharge roller 72 do not convey the sheet P.

### <Transport Control of the Sheet P by the Discharge Unit 70 and the Reversal Double-Sided Unit 50>

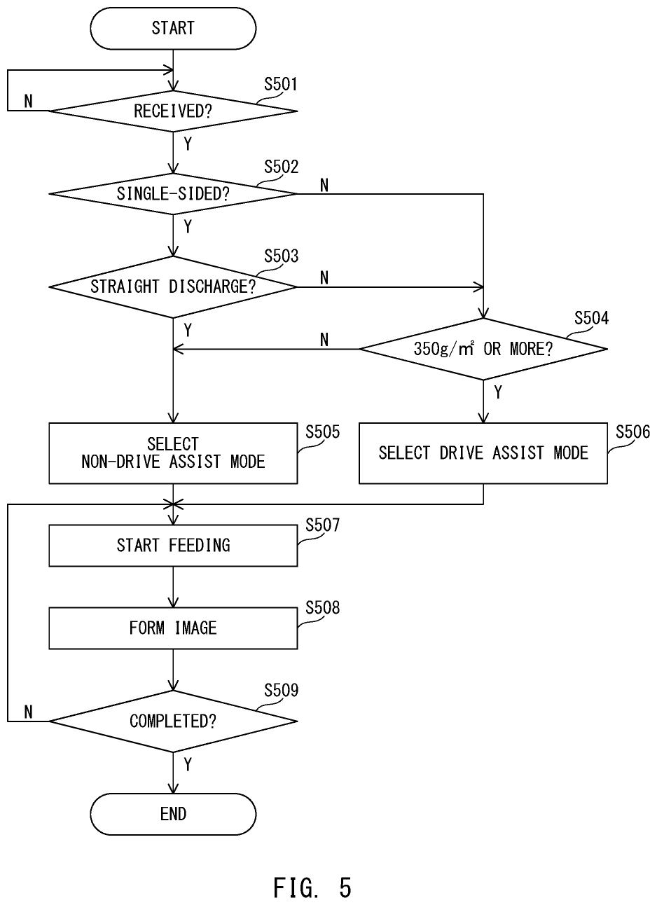

FIG. 5-FIG. 7 are flowcharts representing the conveyance control processes of the sheet P by the discharge unit 70 and the reversal double-sided unit 50. This process is executed by the CPU 201 in the system controller 200.

The process of FIG. 5 includes a process of determining whether or not to assist the driving force from the discharge motor 601 to the reversal rollers 51 and 52 of the reversal double-sided unit 50. In the process of FIG. 5, image formation is performed according to a job.

The CPU 201 performs a warm-up operation when the power of the image forming apparatus 100 is turned ON, and determines whether or not the job has been received in a standby state (Step S501). The CPU 201 determines whether or not the job has been received, for example, depending on whether or not the image forming operation start signal has been obtained from the operation unit 5 or the external device. In a case where the job has not been received (Step S501: N), the CPU 201 enters the standby state.

In a case where the job has been received (Step S501: Y), the CPU 201 determines whether or not the job indicates single-sided printing (Step S502). In a case where the single-sided printing is indicated (Step S502: Y), the CPU 201 determines whether or not the job indicates the straight discharge (Step S503). Due to the process of Step S502 and the process of Step S503, it is determined whether or not the sheet P is to be conveyed to the reversal double-sided unit 50. In this way, it is determined whether or not to perform a driving force assist on the reversal rollers 51 and 52.

In a case where the job indicates the straight discharge (Step S503: Y), the CPU 201 selects a non-drive assist mode in which the driving force assist is not performed (Step S505). In a case where the job instructs double-sided printing (Step S502: N), or in a case where the job does not instruct the straight discharge but instructs the reversal discharge (Step S503: N), the CPU 201 determines whether or not the basis weight of the sheet P used for the image forming is more than or equal to a predetermined amount. The CPU 201 determines, for example, whether or not the basis weight of the sheet P is more than or equal to 350 g/m². Thus, it is determined whether or not the sheet P has a basis weight more than or equal to that of thick paper. As to the sheet P, the driving force during conveying the same increases as the basis weight increases. Therefore, when the basis weight is more than or equal to a predetermined amount, it is necessary to assist the driving force.

When the basis weight of the sheet P is more than or equal to 350 g/m² (Step S504: Y), the CPU 201 selects a drive assist mode for assisting the driving force (Step S506). When the basis weight of the sheet P is less than 350 g/m² (Step S504: N), the CPU 201 selects the non-drive assist mode (Step S505).

The CPU 201, after selecting presence/absence of drive assist, starts to feed the sheet P (Step S507). After that, the CPU 201 forms an image according to the job on the sheet P (Step S508). The CPU 201 discharges the sheet P, on which the image has been formed, to the outside of the image forming apparatus 100 to determine whether or not the image forming instructed by the job is completed (Step S509). If it is not completed (Step S509: N), the CPU 201 starts to feed the next sheet to form an image on the sheet (Steps S507, S508). When it is completed (Step S509: Y), the CPU 201 stops feeding of the sheet P and ends the job. During the process from image forming to discharging, the CPU 201 performs a conveyance control process of the sheet P depending on the presence or absence of the drive assist.

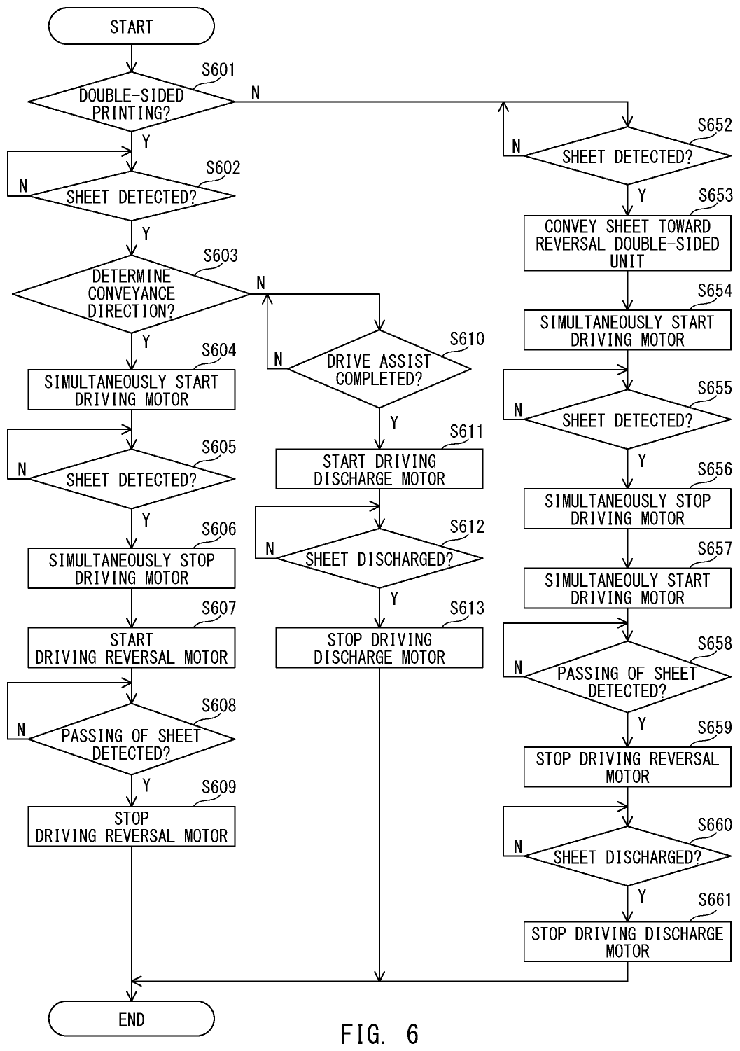

FIG. 6 represents the conveyance control process of the discharge unit 70 and the reversal double-sided unit 50 in the drive assist mode. As described above, the drive assist mode is selected in a case where the sheet P has a basis weight more than or equal to 350 g/m² (thick paper) and the job that requires the sheet P to be drawn into the reversal double-sided unit 50 via the conveyance guide 76, which is a bent portion, is to be performed. The job that requires the sheet P to be drawn into the reversal double-sided unit 50 is a job to instruct double-sided printing or a job to instruct the reversal discharge.

The CPU 201 determines whether or not the job instructs the double-sided printing (Step S601). When the double-sided printing is instructed (Step S601: Y), the CPU 201 waits until the inner discharge sensor 44 detects the sheet P for which the fixing process has been completed (Step S602: N). In a case where the inner discharge sensor 44 detects the sheet P (Step S602: Y), the CPU 201 determines whether to convey the sheet P in the direction toward the reversal double-sided unit 50 or the direction toward the discharge unit 70 (Step S603). The CPU 201 determines the direction to convey the sheet P on which the image forming on the front surface (first surface) has been completed in a direction toward the inner discharge sensor, and to convey the sheet P on which the image forming on the back surface (second surface) has been completed in the direction toward the discharge unit 70.

When the direction toward the reversal double-sided unit 50 is selected as the conveyance direction (Step S603: Y), the CPU 201 simultaneously start, before the reversal sensor 58 detects the sheet P, to drive the reversal motor 600 in the CW direction, and the discharge motor 601 in the CCW direction (Step S604). By driving the reversal roller 51 by two motors, i.e., the reversal motor 600 and the discharge motor 601, the bent portion (conveyance guide 76) can be stably conveyed even in the case of thick paper that requires a high torque. After that, the CPU 201 waits until the reversal double-sided sensor 59 detects the sheet P (Step S605: N). When the reversal double-sided sensor 59 detects the sheet P (Step S605: Y), the CPU 201 simultaneously stops driving the reversal motor 600 and the discharge motor 601 (Step S606).

Next, the CPU 201 starts driving the reversal motor 600 by switching the rotation direction to the CCW direction in order to convey the sheet P in the direction toward the double-sided conveyance unit 60 (Step S607). After the start of driving, when the CPU 201 detects that the sheet P has passed through the reversal double-sided unit 50 by the reversal double-sided sensor 59 (Step S608: Y), the CPU 201 stops driving the reversal motor 600 (Step S609). As a result, the sheet P is conveyed toward the double-sided conveyance unit 60. If the sheet is to be continuously conveyed, the CPU 201 will execute the processing after Step S602.

When the direction toward the discharge unit 70 is selected for the conveyance direction (Step S603: N), the CPU 201 waits until the drive assist for the preceding sheet P by the discharge motor 601 is completed (Step S610: N). When the drive assist is completed (Step S610: Y), the CPU 201 starts driving the discharge motor 601 in the CW direction before the discharge sensor 75 detects the sheet P (Step S611). After that, in a case where the CPU 201 detects that the sheet P has been discharged to the outside of the image forming apparatus 100 by the discharge sensor 75 (Step S612: Y), the CPU 201 stops driving the discharge motor 601 at a timing when the sheet P is removed from the outer discharge roller 72. (Step S613). If the sheet is to be continuously conveyed, the CPU 201 will execute the processing after Step S602.

When the job instructs the single-sided printing (Step S601: N), the CPU 201 waits until the inner discharge sensor 44 detects the sheet P for which the fixing process has been completed (Step S652: N). When the inner discharge sensor 44 detects the sheet P (Step S652: Y), the CPU 201 conveys the sheet P toward the inner discharge sensor (Step S653). Then, the CPU 201 simultaneously starts driving the reversal motor 600 in the CW direction and the discharge motor 601 in the CCW direction before the reversal sensor 58 detects the sheet P (Step S654). By driving the reversal roller 51 by two motors, i.e., the reversal motor 600 and the discharge motor 601, the bent portion (conveyance guide 76) can be stably conveyed even in the case of thick paper that requires the high torque. After that, the CPU 201 waits until the reversal double-sided sensor 59 detects the sheet P (Step S655: N). When the reversal double-sided sensor 59 detects the sheet P (Step S655: Y), the CPU 201 simultaneously stops driving the reversal motor 600 and the discharge motor 601 (Step S656).

Next, the CPU 201 starts driving, in order to convey the sheet P in the direction toward the discharge unit 70, by switching the rotation direction of the reversal motor 600 in the CCW and switching the rotation of the discharge motor 601 in the CCW direction (Step S657). After the start of driving, when the CPU 201 detects that the sheet P has passed through the reversal double-sided unit 50 by the reversal sensor 58 (Step S658: Y), the CPU 201 stops driving the reversal motor 600 (Step S659). After that, in a case where the CPU 201 detects that the sheet P has been discharged to the outside of the image forming apparatus 100 by the discharge sensor 75 (Step S660: Y), the CPU 201 stops driving the discharge motor 601 at a timing when the sheet P is removed from the outer discharge roller 72. (Step S661). If the sheet is to be continuously conveyed, the CPU 201 will execute the processing after Step S652.

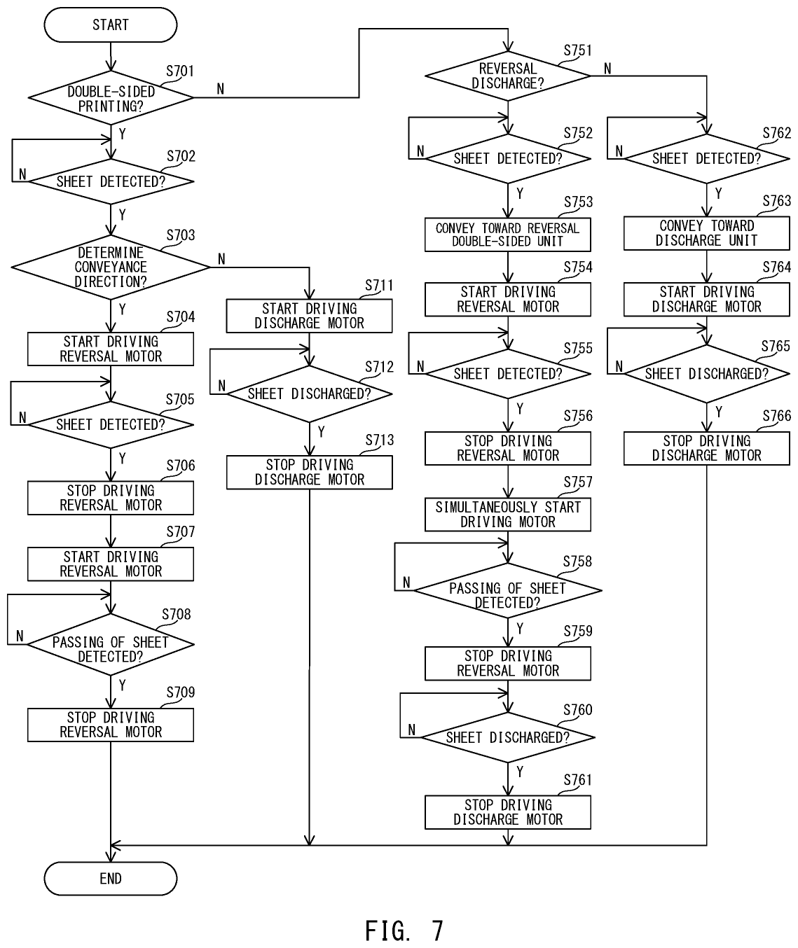

FIG. 7 represents the conveyance control process of the discharge unit 70 and the reversal double-sided unit 50 in the non-drive assist mode. As described above, the non-drive assist mode is performed in the case of the straight discharge or the case of conveying the sheet P having a basis weight of less than 350 g/m².

The CPU 201 determines whether or not the job instructs the double-sided printing (Step S701). When the double-sided printing is instructed (Step S701: Y), the CPU 201 waits until the inner discharge sensor 44 detects the sheet P for which the fixing process has been completed (Step S702: N). In a case where the inner discharge sensor 44 detects the sheet P (Step S702: Y), the CPU 201 determines whether to convey the sheet P in the direction toward the inner discharge sensor or the direction toward the discharge unit 70 (Step S703). The CPU 201 determines the direction to convey the sheet P on which the image forming on the front surface (first surface) has been completed in the direction toward the inner discharge sensor, and to convey the sheet P on which the image forming on the back surface (second surface) has been completed in the direction toward the discharge unit 70.

When the direction toward the reversal double-sided unit 50 is selected as the conveyance direction (Step S703: Y), the CPU 201 starts, before the reversal sensor 58 detects the sheet P, to drive the reversal motor 600 in the CW direction (Step S704). After that, the CPU 201 waits until the reversal double-sided sensor 59 detects the sheet P (Step S705: N). When the reversal double-sided sensor 59 detects the sheet P (Step S705: Y), the CPU 201 simultaneously stops driving the reversal motor 600 (Step S706).

Next, the CPU 201 starts driving the reversal motor 600 by switching the rotation direction to the CCW direction in order to convey the sheet P in the direction toward the double-sided conveyance unit 60 (Step S707). After the start of driving, when the CPU 201 detects that the sheet P has passed through the reversal double-sided unit 50 by the reversal double-sided sensor 59 (Step S708: Y), the CPU 201 stops driving the reversal motor 600 (Step S709). As a result, the sheet P is conveyed toward the double-sided conveyance unit 60. If the sheet is to be continuously conveyed, the CPU 201 will execute the processing after Step S702.

When the direction toward the discharge unit 70 is selected as the conveyance direction (Step S703: N), the CPU 201 starts driving the discharge motor 601 in the CW direction before the discharge sensor 75 detects the sheet P (Step S711). After that, in a case where the CPU 201 detects that the sheet P has been discharged to the outside of the image forming apparatus 100 by the discharge sensor 75 (Step S712: Y), the CPU 201 stops driving the discharge motor 601 at a timing when the sheet P is removed from the outer discharge roller 72. (Step S713). If the sheet is to be continuously conveyed, the CPU 201 will execute the processing after Step S702.

In a case where the job indicates single-sided printing (Step S701: N), the CPU 201 determines whether or not the job indicates the reversal discharge (Step S751). When the reversal discharge is instructed (Step S751: Y), the CPU 201 waits until the inner discharge sensor 44 detects the sheet P for which the fixing process has been completed (Step S752: N). When the inner discharge sensor 44 detects the sheet P (Step S752: Y), the CPU 201 conveys the sheet P toward the inner discharge sensor (Step S753). Then, the CPU 201 simultaneously starts driving the reversal motor 600 in the CW direction before the reversal sensor 58 detects the sheet P (Step S754). After that, the CPU 201 waits until the reversal double-sided sensor 59 detects the sheet P (Step S755: N). When the reversal double-sided sensor 59 detects the sheet P (Step S755: Y), the CPU 201 simultaneously stops driving the reversal motor 600 and the discharge motor 601 (Step S756).

Next, the CPU 201 starts driving, in order to convey the sheet P in the direction toward the discharge unit 70, by switching the rotation direction of the reversal motor 600 in the CCW and switching the rotation of the discharge motor 601 in the CCW direction (Step S757). After the start of driving, when the CPU 201 detects that the sheet P has passed through the reversal double-sided unit 50 by the reversal sensor 58 (Step S758: Y), the CPU 201 stops driving the reversal motor 600 (Step S759). After that, in a case where the CPU 201 detects that the sheet P has been discharged to the outside of the image forming apparatus 100 by the discharge sensor 75 (Step S760: Y), the CPU 201 stops driving the discharge motor 601 at a timing when the sheet P is removed from the outer discharge roller 72. (Step S761). If the sheet is to be continuously conveyed, the CPU 201 will execute the processing after Step S752.

When the straight discharge is instructed by the job (Step S751: N), the CPU 201 waits until the inner discharge sensor 44 detects the sheet P for which the fixing process has been completed (Step S762: N). In a case where the inner discharge sensor 44 detects the sheet P (Step S762: Y), the CPU 201 determines whether to convey the sheet P in the direction toward the discharge unit 70 (Step S763). Next, the CPU 201 starts driving the discharge motor 601 in the CW direction before the discharge sensor 75 detects the sheet P (Step S764). After that, in a case where the CPU 201 detects that the sheet P has been discharged to the outside of the image forming apparatus 100 by the discharge sensor 75 (Step S765: Y), the CPU 201 stops driving the discharge motor 601 at the timing when the sheet P is removed from the outer discharge roller 72. (Step S766). If the sheet is to be continuously conveyed, the CPU 201 will execute the processing after Step S762.

### <Conveyance Timing of the Sheet P by the Discharge Unit 70 and the Reversal Double-Sided Unit 50>

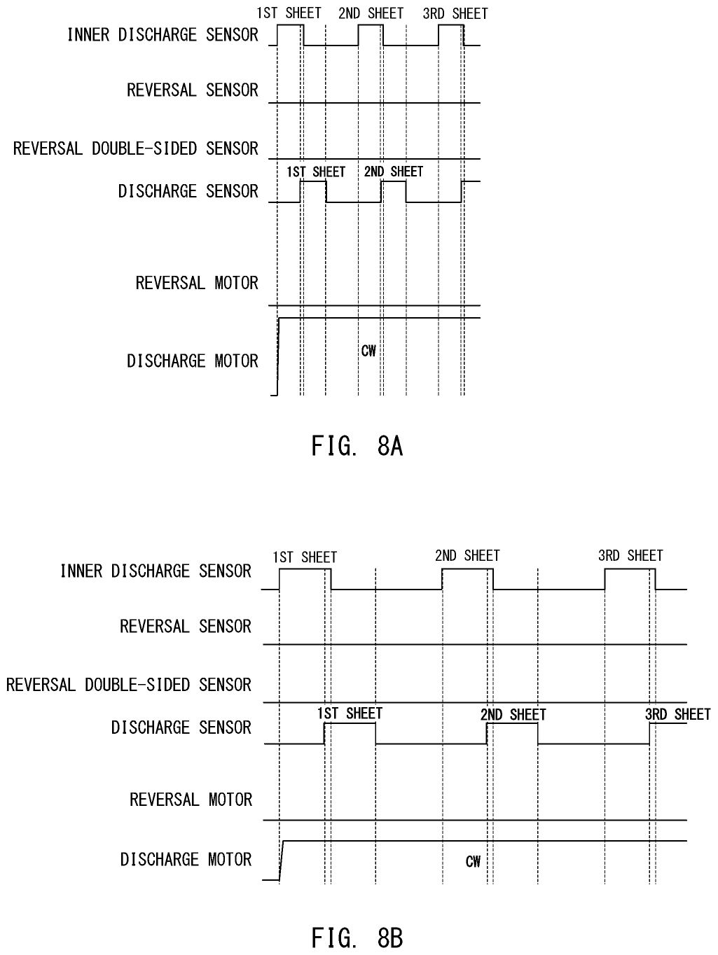

FIG. 8A and FIG. 8B are timing charts which represent the conveyance timing of the sheet P in the case of performing the straight discharge in one side printing.

FIG. 8A represents the detection results of the sensors and the driving control signals for drive control of the motors when the plain paper is conveyed. In the case of the straight discharge, the reversal motor 600 does not operate because the sheet P that has passed the detection position of the inner discharge sensor 44 is conveyed in the direction toward the discharge unit 70. The discharge motor 601 starts driving at a timing when the inner discharge sensor 44 detects a leading edge of the first sheet P. At this time, the rotation direction of the discharge motor 601 is the CW direction, and the driving force is transmitted to the outer discharge roller 72. The discharge motor 601 is driven until the end of the job.

FIG. 8B represents the detection results of the sensors and the driving control signals for drive control of the motors when thick paper is conveyed. As in FIG. 8A, in the case of the straight discharge, the reversal motor 600 does not operate because the sheet P that has passed the detection position of the inner discharge sensor 44 is conveyed in the direction toward the discharge unit 70. The discharge motor 601 starts driving at a timing when the inner discharge sensor 44 detects a leading edge of the first sheet P. At this time, the rotation direction of the discharge motor 601 is the CW direction, and the driving force is transmitted to the outer discharge roller 72. The discharge motor 601 is driven until the end of the job.

The conveyance speed for thick paper is set to be slower than that for the plain paper, and the rotation speed for the discharge motor 601 is also set to be slower than that for the plain paper. For example, the conveyance speed of thick paper is half the conveyance speed for the plain paper, and the rotation speed of the discharge motor 601 is also half the rotation speed for the plain paper. In the case of the straight discharge, since the reversal roller 51 is not driven, the operation is performed in the non-drive assist mode.

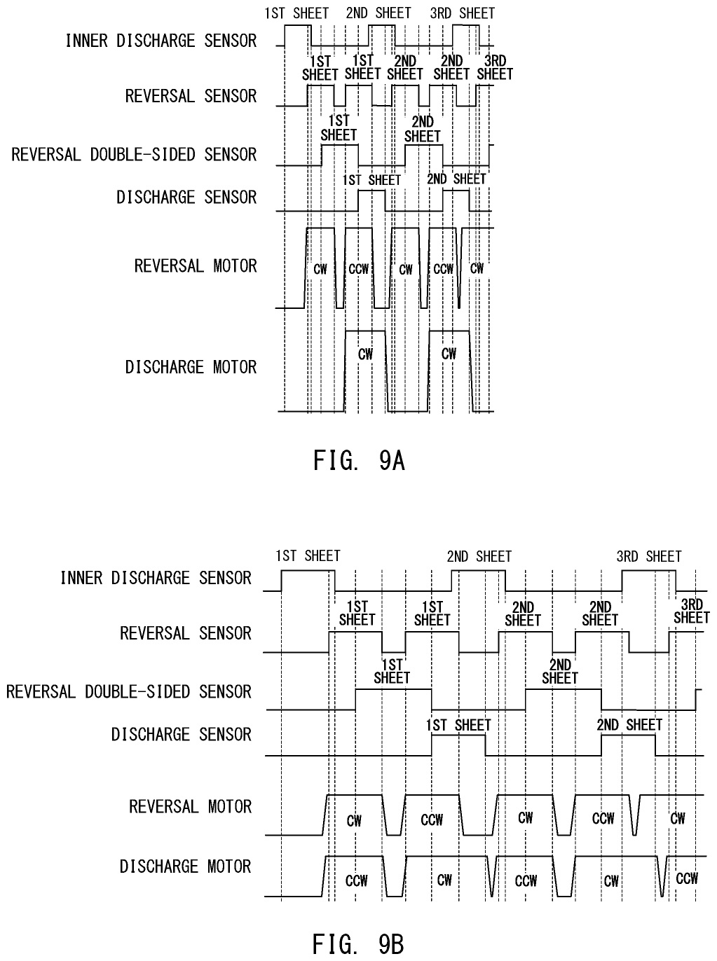

FIG. 9A and FIG. 9B are timing charts representing the conveyance timing of the sheet P when performing the reversal discharge by single-sided printing.

FIG. 9B represents the detection results of the sensors and the driving control signals for drive control of the motors when the plain paper is conveyed. In the case of the reversal discharge, the sheet P that has passed the detection position of the inner discharge sensor 44 is conveyed toward the inner discharge sensor. The reversal motor 600 starts driving in the CW direction after the inner discharge sensor 44 detects a leading edge of the first sheet P and after the reversal sensor 58 detects the leading edge of the sheet P. At a timing when the reversal sensor 58 detects a trailing edge of the sheet P, the reversal motor 600 is stopped. Then, in order to convey the sheet P in the direction toward the discharge unit 70, the rotation direction of the reversal motor 600 is switched to the CCW direction and the reversal motor 600 and the discharge motor 601 are driven. At this time, the rotation direction of the discharge motor 601 is the CW direction, and operates such that the driving force is transmitted to the pre-discharge roller 73 and the outer discharge roller 72. For the second and subsequent sheets, it also operates at the same timing.

When the reversal discharge of the plain paper is performed as described above, the operation is performed in the non-drive assist mode. Although the discharge motor 601 is intermittently driven in the present embodiment, the discharge motor 601 may be continuously rotationally driven in the CW direction without stopping.

FIG. 9B represents the detection results of the sensors and the driving control signals for drive control of the motors when thick paper is conveyed. In the case of the reversal discharge, the sheet P that has passed the detection position of the inner discharge sensor 44 is conveyed toward the inner discharge sensor. The reversal motor 600 and the discharge motor 601 simultaneously start driving after the inner discharge sensor 44 detects a leading edge of the first sheet P and after the reversal sensor 58 detects the leading edge of the sheet P. At this time, the reversal motor 600 rotates in the CW direction, the discharge motor 601 rotates in the CCW direction, and the reversal roller 51 is driven to rotate by the driving force of two motors. At a timing when the reversal sensor 58 detects the trailing edge of the sheet P, the reversal motor 600 and the discharge motor 601 is stopped.

After that, in order to convey the sheet P in the direction toward the discharge unit 70, the rotation direction of the reversal motor 600 is switched to the CCW direction and the rotation direction of the discharge motor 601 is switched to the CW direction to thereby drive the reversal motor 600 and the discharge motor 601. When the reversal sensor 58 detects the trailing edge of the sheet P conveyed in the direction toward the discharge unit 70, the reversal motor 600 is stopped. After the discharge sensor 75 has detected the trailing edge of the sheet P to be discharged to the outside of the image forming apparatus 100, the discharge motor 601 stops at a timing when the sheet P passes the detection position of the outer discharge roller 72. For the second and subsequent sheets, it also operates at the same timing. As described above, in a case where the reversal discharge is performed on the thick paper, to drive the reversal roller 51 with an assist by the discharge motor 601, the sheet P is conveyed in the drive assist mode.

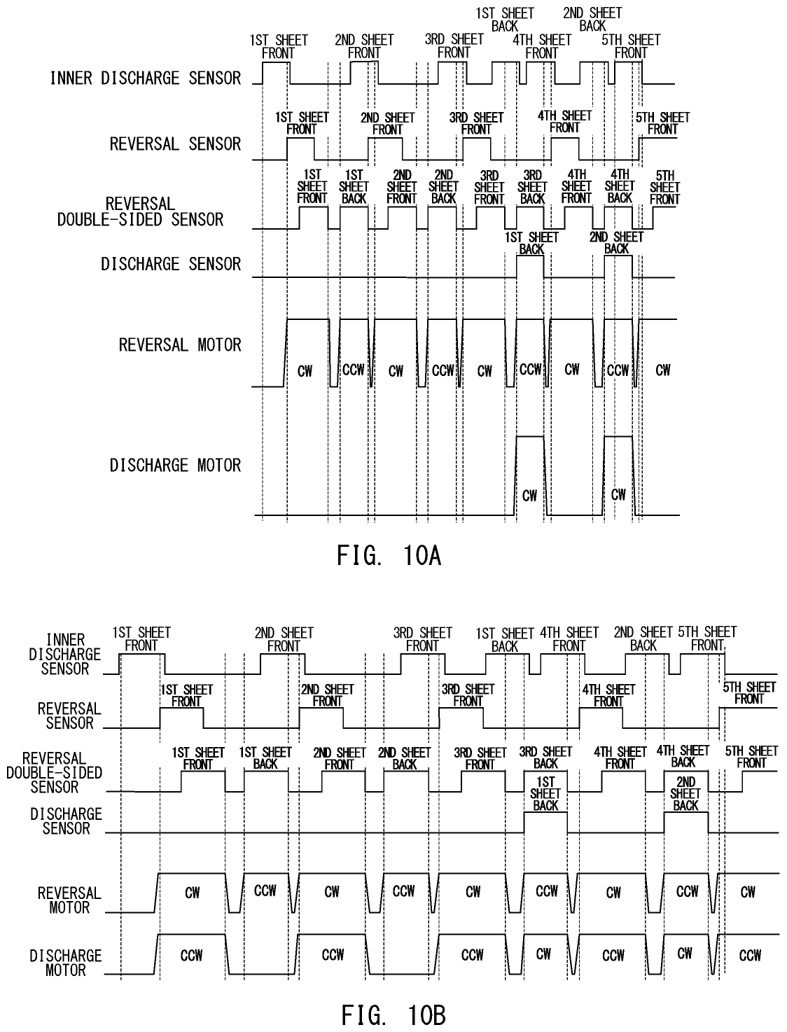

FIG. 10A and FIG. 10B are timing charts representing the conveyance timing of the sheet P at the time of double-sided printing.

FIG. 10A represents a detection result of each sensor and a drive control signal of each motor when the plain paper is to be conveyed. In the case of the double-sided printing, the sheet P that has passed the detection position of the inner discharge sensor 44 after the image forming on the front surface (first surface) is completed is conveyed to the inner discharge sensor. The reversal motor 600 starts driving in the CW direction after the inner discharge sensor 44 detects a leading edge of the first sheet P and after the reversal sensor 58 detects the leading edge of the sheet P. When the reversal double-sided sensor 59 detects a trailing edge of the sheet P, the reversal motor 600 is stopped.

Next, CPU 201 starts driving the reversal motor 600 by switching the rotation direction to the CCW direction in order to convey the sheet P in the direction toward the double-sided conveyance unit 60. When the reversal double-sided sensor 59 detects the trailing edge of the sheet P conveyed in the direction toward the discharge unit 70, the reversal motor 600 is stopped. The reversal motor 600 operates at the same timing for the second and subsequent sheets.

After the image forming on the front surface of the third sheet is completed and the third sheet has passed the detection position of the inner discharge sensor 44, the first sheet, having a back surface (second surface) on which an image is formed, is conveyed. The sheet P that has passed the detection position of the inner discharge sensor 44 after the image forming on the back surface is completed is conveyed in the direction toward the discharge unit 70. After the inner discharge sensor 44 detects the leading edge of the first sheet P having a back surface on which the image forming is completed and before the sheet P arrives at the outer discharge roller 72, the discharge motor 601 starts driving. Then, the discharge motor 601 stops at the timing when the first sheet P passes, after the trailing edge of the first sheet P to be discharged to the outside of the image forming apparatus 100 is detected by the discharge sensor 75, the outer discharge roller 72. At this time, the rotation direction of the discharge motor 601 is the CW direction, and operates such that the driving force is transmitted to the pre-discharge roller 73 and the outer discharge roller 72. The discharge motor 601 operates at the same timing for the second and subsequent sheets.

In the case of double-sided printing of the plain paper, the operation is performed in the non-drive assist mode. Although the discharge motor 601 is intermittently driven in the present embodiment, the discharge motor 601 may be continuously driven in the CW direction without stopping. Further, in the double-sided printing of the present embodiment, for the third and subsequent sheets, a sheet with its front surface printed and a sheet with its back surface printed are to be conveyed alternatively.

FIG. 10B represents the detection results of the sensors and the driving control signals for drive control of the motors when thick paper is conveyed. In the case of the double-sided printing, the sheet P that has passed the detection position of the inner discharge sensor 44 after the image forming on the front surface (first surface) is completed is conveyed to the inner discharge sensor. The reversal motor 600 and the discharge motor 601 simultaneously start driving after the inner discharge sensor 44 detects a leading edge of the first sheet P and after the reversal sensor 58 detects the leading edge of the sheet P. At this time, the reversal motor 600 rotates in the CW direction, the discharge motor 601 rotates in the CCW direction, and the reversal roller 51 is driven to rotate by the driving force of two motors. At a timing when the reversal double-sided sensor 59 detects the trailing edge of the sheet P, the reversal motor 600 and the discharge motor 601 is stopped.

Then, CPU 201 starts driving the reversal motor 600 by switching the rotation direction to the CCW direction in order to convey the sheet P in the direction toward the discharge unit 70. When the reversal double-sided sensor 59 detects the trailing edge of the sheet P conveyed in the direction toward the discharge unit 70, the reversal motor 600 is stopped. The reversal motor 600 operates at the same timing for the second and subsequent sheets.

After the image forming on the front surface of the third sheet is completed and the third sheet has passed the detection position of the inner discharge sensor 44, the first sheet, having a back surface (second surface) on which an image is formed, is conveyed. The sheet P that has passed the detection position of the inner discharge sensor 44 after the image forming on the back surface is completed is conveyed in the direction toward the discharge unit 70.

The discharge motor 601 draws a preceding sheet P in the reversal double-sided unit 50 at a timing when the inner discharge sensor 44 detects a leading edge of the first sheet P having a back surface on which the image forming is completed. Therefore, the reversal roller 51 is driven with assist. The discharge motor 601 stops at a timing when the reversal double-sided sensor 59 detects the trailing edge of the preceding sheet P. After that, the discharge motor 601 switches the rotation direction to the CW direction and starts driving. The discharge motor 601 starts driving before the sheet P reaches the detection position of the discharge sensor 75. Then, the discharge sensor 75 detects the trailing edge of the sheet P to be discharged to the outside of the image forming apparatus 100, and the discharge motor 601 stops at a timing when the sheet P passes the detection position of the outer discharge roller 72.

In the case of double-sided printing of thick paper, the operation is performed in the drive assist mode. Therefore, the discharge motor 601 drives the reversal roller 51 with assist.

As described above, in the image forming apparatus 100 of the present embodiment, when a condition in which the high torque is required at a portion for conveying the sheet P by the reversal roller 51 is met, the driving force of the motor (drive source) that is not originally used for conveying the sheet P at the portion assists the conveyance of the sheet P.

The condition in which the high torque is required is, for example, to convey the sheet P to a bent portion such as the conveyance guide 76, or to convey a type of sheet that requires the high torque for conveying the same, such as thick paper. With the assist of the driving force, the sheet P can be stably conveyed even when the condition in which the high torque is required is satisfied. In this way, the image forming apparatus 100 can increase the output of the driving force for conveying the sheet without adding new drive source or significantly increasing the cost.

In the above description, the assist of the driving force when the sheet passes through the conveyance guide 76 has been described. In addition to this position, the assist of the driving force is provided at, for example, a path between the reversal roller 52 and the double-sided conveyance roller 61, or a path between the double-sided conveyance roller 65 and the conveyance roller 24. Even at these positions, when conveying thick paper, the driving force of the double-sided conveyance roller 61 and the conveyance roller 24 may be applied from a motor other than the motor that is originally designed to provide the driving force to these rollers.

The sheet conveyance apparatus of the present embodiment can be applied, as well as the image forming apparatus 100, to any apparatus having a configuration for conveying the sheet. For example, the sheet conveyance apparatus of the present embodiment can be applied to an image reading apparatus such as a scanner having a bent portion in a conveyance guide. In this case, in order to stabilize the conveyance speed of the sheet (original) at the time of image reading, appropriate conveyance speed control and position control are performed. Further, according to the sheet conveyance apparatus of the present disclosure, by supplying a high the to the conveyance roller as necessary, it is possible to suppress an increase in cost and to stably convey the sheet.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2021-081415, filed May 13, 2021, which is hereby incorporated by reference herein in its entirety.

What is claimed is:

1. A sheet conveyance apparatus comprising:
a first conveyance roller configured to convey a sheet;
a second conveyance roller, arranged downstream of the first conveyance roller in a conveyance direction in which the sheet is conveyed, configured to convey the sheet;
a first conveyance path configured to guide the sheet from the first conveyance roller to the second conveyance roller;
a second conveyance path, which is branched from the first conveyance path between the first conveyance roller and the second conveyance roller to guide the sheet, the second conveyance path having a bent portion;
a third conveyance roller configured to convey the sheet guided by the second conveyance path;
a first motor configured to drive the third conveyance roller;
a second motor;
a first transmission mechanism configured to transmit driving force of the second motor to the second conveyance roller; and
a second transmission mechanism configured to transmit the driving force of the second motor to the third conveyance roller,
wherein, in a case where the sheet is conveyed by the second conveyance roller, the driving force of the second motor is transmitted to the second conveyance roller by the first transmission mechanism and the driving force of the second motor is not transmitted to the third conveyance roller,
wherein, in a case where the sheet is conveyed by the third conveyance roller, the driving force of the second motor is transmitted to the third conveyance roller by the second transmission mechanism and the driving force of the second motor is not transmitted to the second conveyance roller, and
wherein, in a case where the sheet is conveyed by the third conveyance roller, the third conveyance roller is driven by both the first motor and the second motor.

2. The sheet conveyance apparatus according to claim 1, wherein:
the first transmission mechanism is configured to transmit the driving force of the second motor rotating in a first direction to the second conveyance roller;
the first transmission mechanism is configured to not transmit the driving force of the second motor rotating in a second direction opposite to the first direction to the second conveyance roller;
the second transmission mechanism is configured to not transmit the driving force of the second motor rotating in the first direction to the third conveyance roller;
the second transmission mechanism is configured to transmit the driving force of the second motor rotating in the second direction to the third conveyance roller; and
the second motor is configured to rotate in the first direction in a case where the sheet is conveyed by the second conveyance roller and rotate in the second direction in a case where the sheet is conveyed by the third conveyance roller.

3. The sheet conveyance apparatus according to claim 2,
wherein the first transmission mechanism has a gear connected to the second motor and a one-way clutch gear connected to the second conveyance roller, and the first transmission mechanism is configured to transmit the driving force of the second motor to the second conveyance roller in a case where the second motor rotates in the first direction,
wherein the second transmission mechanism has an idler gear and a one-way clutch gear, and the second transmission mechanism is configured to transmit the driving force of the second motor to the first conveyance roller in a case where the second motor rotates in the second direction.

4. The sheet conveyance apparatus according to claim 3, further comprising an idler gear axis connected to the idler gear,
wherein the gear of the first transmission mechanism and the idler gear of the second transmission mechanism are connected, and
wherein the idler gear axis is configured to pivotally support the one-way clutch gear of the second transmission mechanism.

5. The sheet conveyance apparatus according to claim 4,
wherein the first transmission mechanism has a gear connected to the first motor and a two-stage gear connected to the first conveyance roller,
wherein the two-stage gear and the one-way clutch gear of the second transmission mechanism are connected.

6. The sheet conveyance apparatus according to claim 1,
wherein the first motor and the second motor simultaneously start driving when transmitting the driving force of the second motor to the first conveyance roller via the second transmission mechanism.

7. The sheet conveyance apparatus according to claim 2,
wherein the sheet conveyance apparatus further comprising a controller configured to obtain information concerning basis weight of the sheet,
wherein the controller is configured to:
control, in a case where the basis weight of the sheet is larger than a predetermined amount and the sheet is conveyed by the second conveyance roller, the second motor to rotate in the first direction and;
control, in a case where the basis weight of the sheet is larger than the predetermined amount and the sheet is conveyed by the third conveyance roller, the second motor to rotate in the second direction, and
wherein the controller is configured to:
control, in a case where the basis weight of the sheet is smaller than the predetermined amount and the sheet is conveyed by the second conveyance roller, the second motor to rotate in the first direction and;
not control, in a case where the basis weight of the sheet is smaller than the predetermined amount and the sheet is conveyed by the third conveyance roller, the second motor to rotate in the second direction.

8. An image forming apparatus comprising:
a transfer unit configured to transfer an image on a recording medium;
a fixing unit configured to fix the image transferred on the recording medium by the transfer unit on the recording medium with heat;
a discharge roller configured to discharge the recording medium on which a first image as the image is fixed by the fixing unit to an outside of the image forming apparatus;
a first conveyance path configured to guide the recording medium to the discharge roller from the fixing unit;
a second conveyance path configured to guide the recording medium having a first surface on which the first image is fixed by the fixing unit and a second surface, which is an opposite side of the first surface, on which a second image as the image is to be formed, wherein the second conveyance path is branched from the first conveyance path between the fixing unit and the discharge roller, and the second conveyance path has a bent portion;
a conveyance roller configured to convey the recording medium guided by the second conveyance path;
a first motor configured to drive the conveyance roller;
a second motor;
a first transmission mechanism configured to transmit driving force of the second motor to the discharge roller; and
a second transmission mechanism configured to transmit the driving force of the second motor to the conveyance roller,
wherein, in a case where the recording medium is conveyed by the discharge roller, the driving force of the second motor is transmitted to the discharge roller by the first transmission mechanism and the driving force of the second motor is not transmitted to the conveyance roller,
wherein, in a case where the recording medium is conveyed by the conveyance roller, the driving force of the second motor is transmitted to the conveyance roller by the second transmission mechanism and the driving force of the second motor is not transmitted to the discharge roller,
wherein, in a case where the recording medium is conveyed by the conveyance roller, the conveyance roller is driven by both the first motor and the second motor.

9. The image forming apparatus according to claim 8, wherein:
the first transmission mechanism is configured to transmit the driving force of the second motor rotating in a first direction to the discharge roller;
the first transmission mechanism is configured to not transmit the driving force of the second motor rotating in a second direction opposite to the first direction to the discharge roller;
the second transmission mechanism is configured to not transmit the driving force of the second motor rotating in the first direction to the conveyance roller;
the second transmission mechanism is configured to transmit the driving force of the second motor rotating in the second direction to the conveyance roller;
the second motor is configured to rotate in the first direction in a case where the sheet is conveyed by the discharge roller, and
the second motor is configured to rotate in the first direction in a case where the sheet is conveyed by the conveyance roller.

10. The image forming apparatus according to claim 9,
wherein the first transmission mechanism has a gear connected to the second motor and a one-way clutch gear connected to the discharge roller, and the first transmission mechanism is configured to transmit the driving force of the second motor to the discharge roller in a case where the second motor rotates in the first direction,
wherein the second transmission mechanism having an idler gear and a one-way clutch gear, and the second transmission mechanism is configured to transmit the driving force of the second motor to the first conveyance roller in a case where the second motor rotates in the second direction,

11. The image forming apparatus according to claim 10, further comprising an idler gear axis connected to the idler gear,
wherein the gear of the first transmission mechanism and the idler gear of the second transmission mechanism are connected, and
wherein the idler gear axis is configured to pivotally support the one-way clutch gear of the second transmission mechanism.

12. The image forming apparatus according to claim 11,
wherein the first transmission mechanism has a gear connected to the first motor and a two-stage gear connected to the first conveyance roller,
wherein the two-stage gear and the one-way clutch gear of the second transmission mechanism are connected to each other.

13. The image forming apparatus according to claim 8,
the first motor and the second motor simultaneously start driving when transmitting the driving force of the second motor to the first conveyance roller via the second transmission mechanism.

14. The image forming apparatus according to claim 9,
wherein the image forming apparatus further comprising a controller configured to obtain information concerning basis weight of the sheet,
wherein the controller is configured to:
control, in a case where the basis weight of the sheet is larger than a predetermined amount and the sheet is conveyed by the second conveyance roller, the second motor to rotate in the first direction and;
control, in a case where the basis weight of the sheet is larger than the predetermined amount and the sheet is conveyed by the third conveyance roller, the second motor to rotate in the second direction,
wherein the controller is configured to:
control, in a case where the basis weight of the sheet is smaller than the predetermined amount and the sheet is conveyed by the second conveyance roller, the second motor to rotate in the first direction and;
not control, in a case where the basis weight of the sheet is smaller than the predetermined amount and the sheet is conveyed by the third conveyance roller, the second motor to rotate in the second direction.
